(19) United States
(12) Patent Application Publication
(10) Pub. No.: US 2005/0218235 A1
(43) Pub. Date: Oct. 6, 2005

(54) Editable radio frequency identification device and system for editing the same

(75) Inventors: Kai-Cheng Chang, Taipei City (TW); Ming-Hsiu Hsu, Nantou City (TW); Pei-Fang Liang, Beigang Township (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Chutung (TW)

(21) Appl. No.: 10/862,565

(22) Filed: Jun. 8, 2004

(30) Foreign Application Priority Data
Mar. 31, 2004 (TW) 093109823

(51) Int. Cl. G06K 19/06

(52) U.S. Cl. 235/492

(57) ABSTRACT

The present invention provides an editable radio frequency identification device and system for editing the same. The editable radio frequency identification device includes antenna and a substrate having two adjacent zones formed thereon an editable area and a transducer. The editable area is provided for a writing device to define a pattern representing an identification code thereon. The antenna device is provided for receiving external signal and the transducer converts the received signal into surface acoustic wave for being transmitted to the editable area. The writing device can be a light emitting device, a punch, a stamp, or a printing apparatus.

### BACKGROUND OF THE INVENTION

1. Field of the Invention

The present invention relates to a radio frequency identification device (RFID) and, more particularly, to an editable RFID device and system for editing the RFID device.

2. Description of Related Art Conventionally, bar codes are widely used in many applications. For example, bar codes are used to represent the number or symbol of an object (e.g., a piece of goods). As shown in FIG. 1, a bar code 11 is adhered or printed on a piece of goods 12. A bar code reader 13 is adapted to approach the bar code 11 on the piece of goods 12 for reading the number or symbol. The read data is then sent to a database 14 for comparison so that a subsequent process can be done.

The above prior bar code system has a drawback of requiring the bar code reader 13 to read the bar code 11 in close proximity (i.e., almost being in contact therewith the bar code 11). For overcoming the above drawback, reading data from a radio frequency identification (RFID) device in a non-contact manner is provided as shown in FIG. 2. As illustrated, the RFID device comprises a substrate 21 formed of a piezoelectric material, an antenna 22, a finger-shaped transducer 24 and a stripe-shaped reflecting member 23 formed on the substrate 21. The transducer 24 is coupled to the antenna 22. The stripe-shaped reflecting member 23 has a specific pattern and different pattern represents different information. In operation, the antenna 22 is adapted to receive electromagnetic waves transmitted from a reader (not shown). The received electromagnetic waves are then converted into surface acoustic waves by the transducer 24 in cooperation with the piezoelectric property of the substrate 21. The surface acoustic waves are then sent to the stripe-shaped reflecting member 23 for being reflected to the transducer 24. Next, the transducer 24 is adapted to convert the surface acoustic waves into electromagnetic waves. Finally, the electromagnetic waves are transmitted from the antenna 22 so as to be received by the reader.

The prior RFID device shown in FIG. 2 can generate different reflections by having the stripe-shaped reflecting member 23 of different patterns. The reflections are then converted into electromagnetic waves representing different information. FIGS. 3A to 3D depict the manufacturing process of the RFID device. At first, a metal layer 32 and a photo-resist layer 33 are sequentially formed on the metal layer 32 (see FIG. 3A). The pattern of the transducer 24 and stripe-shaped reflecting member 23 are formed on the photo-resist layer 33 by masking (see FIG. 3B). Next, the metal layer 32 is etched to remove the exposed portion thereof (see FIG. 3C). Finally, the remaining photo-resist layer 33 is removed to form patterns of the transducer 24 and the stripe-shaped reflecting member 23 on the substrate 31 (see FIG. 3D).

As stated above, the stripe-shaped reflecting member 23 of the RFID device represents specific information. Typically, the stripe-shaped reflecting member 23 has been formed by the above semiconductor process when the RFID device is manufactured. Thus, the required manufacturing process is complicated and the use of RFID device is inflexible. A user only can purchase an RFID device with a stripe-shaped reflecting member 23 with required information already contained therein. In other words, the user is not allowed to modify the information. Thus, the RFID device is disadvantageous for being inconvenient in use and expensive, and hardly replacing the existing bar code.

There have been numerous suggestions in prior patents about RFID device. For example, U.S. Pat. No. 6,144,332 granted to Reindl, et al. for a “Passive surface wave sensor which can be wirelessly interrogated” is disclosed to prevent external factors (e.g., temperature) from adversely affecting the operation of sensor. U.S. Pat. No. 6,206,292 granted to Robertz, et al. for a “Surface-printable RFID-transponder” discloses a process to simplify the construction of labels or tags for transported goods, identification cards, access authorization cards and the like, in which a printable/writable layer comprising particulate pigment and film forming binder are provided on a continuous polymer film so that sensors can detect the beginning and end of the respective RFID transponder in the strip and can control the in-register printing of the RFID transponders., thereby realizing an efficient mass production. Therefore, the above patent is provided to improve the manufacturing efficiency of RFID transponders. However, the printable/writable layer has been written with information when being manufactured, and thus the user is still not allowed to modify the information, resulting in inconvenience in use of the RFID-transponder. Hence, a need for improvement exists.

### SUMMARY OF THE INVENTION

An object of the present invention is to provide an editable RFID device and a system for editing the RFID device so that a user may edit the RFID device as desired.

Another object of the present invention is to provide an editable RFID device and a system for editing the RFID device so that data can be easily written into the RFID device by editing.

In accordance with one aspect of the present invention, there is provided an editable RFID device, which includes: a substrate including a first zone and an adjacent second zone on its top surface; an editable area formed on the first zone for being operative to form a specific pattern representing an identification code thereon by means of a writing device; a transducer formed on the second zone; and an antenna connected to the transducer, and receiving electromagnetic waves, wherein the transducer is operative to convert the electromagnetic waves into surface acoustic waves for being sent to the first zone.

In accordance with another aspect of the present invention, there is provided a system for editing radio frequency identification device, which includes: a writing device and a radio frequency identification device. The radio frequency identification device includes: a substrate including a first zone and an adjacent second zone on its top surface; an editable area formed on the first zone for being operative to form a specific pattern representing an identification code thereon by means of the writing device; a transducer formed on the second zone; and an antenna connected to the transducer, and receiving electromagnetic waves, wherein the transducer is operative to convert the electromagnetic waves into surface acoustic waves for being sent to the first zone.

Other objects, advantages, and novel features of the present invention will become more apparent from the detailed description when taken in conjunction with the accompanying drawings.

### BRIEF DESCRIPTION OF THE DRAWINGS

FIG. 1 depicts the operation of a conventional bar code system;

FIG. 2 is a perspective view of a well-known RFID device;

FIGS. 3A to 3D are side views for illustrating a manufacturing process of the RFID device shown in FIG. 2;

FIG. 4 is a perspective view of an editable RFID device in accordance with the present invention; and

FIG. 5 schematically illustrates a first embodiment of a system for editing RFID devices in accordance with the present invention;

FIG. 6 schematically illustrates a second embodiment of a system for editing RFID devices in accordance with the present invention;

FIG. 7 schematically illustrates a third embodiment of a system for editing RFID devices in accordance with the present invention; and

FIG. 8 schematically illustrates a fourth embodiment of a system for editing RFID devices in accordance with the present invention.

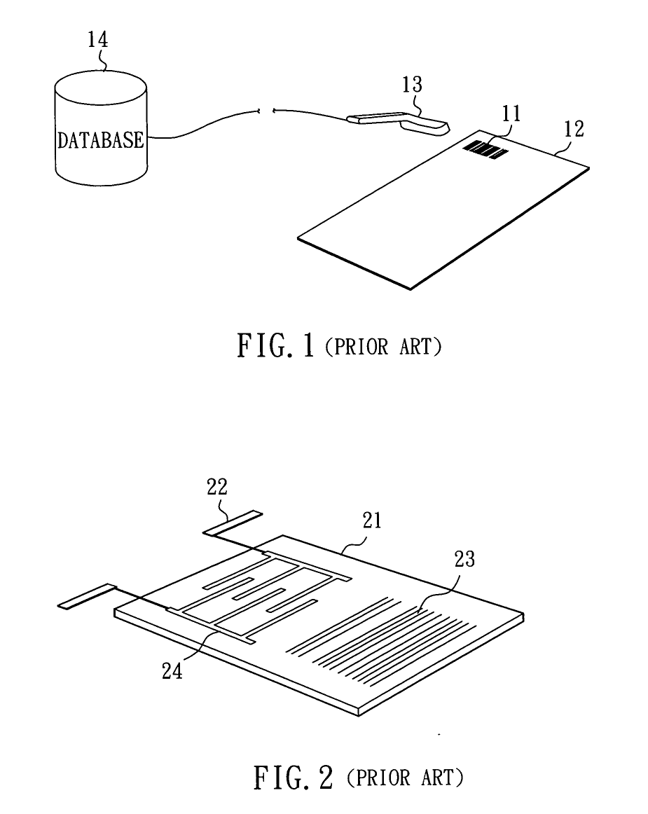

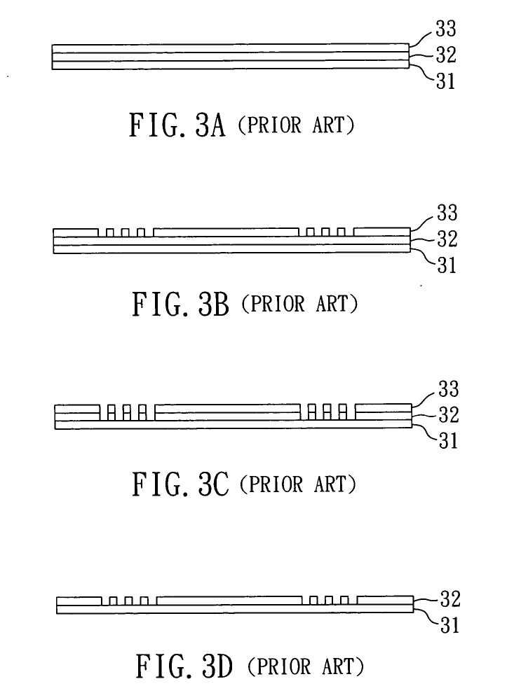

### DETAILED DESCRIPTION OF THE PREFERRED EMBODIMENT

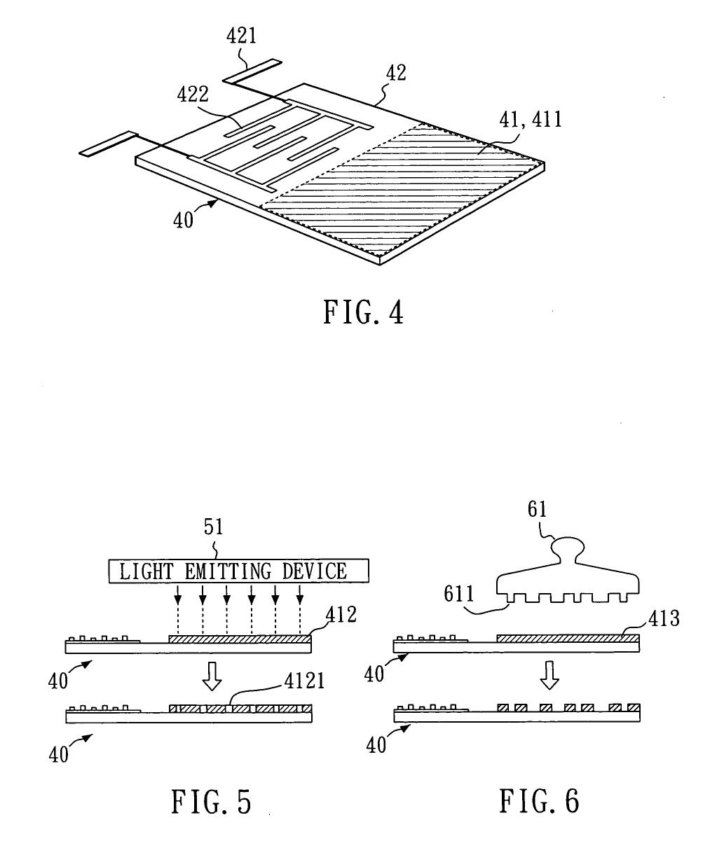

With reference to FIG. 4, there is shown an editable RFID device in accordance with the present invention, which includes a substrate 40 and an antenna 421. A first zone 41 and a second zone 42 adjacent to the first zone 41 are formed on a top surface of the substrate 40. An editable area 411 is formed on the first zone 41. A finger-shaped transducer 422 is formed on the second zone 42. The antenna 421 is connected to the transducer 422. The antenna 421 receives electromagnetic waves, and in turn, the transducer 422 converts the electromagnetic waves into surface acoustic waves for being sent to the first zone 41. The transducer 422 is formed on the substrate 40 by a known RFID manufacturing process.

The editable area 411 on the substrate 40 is provided for a user to operate a writing device to define thereon a specific pattern representing an identification code. That is, the editable area 411 is a blank region without any information when the editable RFID device is manufactured. This enables a user to write information into the editable area 411 as desired.

With reference to FIG. 5, there is shown a first embodiment of a system for editing RFID devices in accordance with the present invention, wherein the writing device is a light emitting device 51 and the editable area 411 is a photosensitive layer 412 formed on the first zone 41 of the substrate 40. The light emitting device 51 emits light having a predetermined pattern, so as to illuminate a predetermined portion of the photosensitive layer 412. As such, chemical property of the illuminated portion 4121 of the photosensitive layer 412 is different from that of the non-illuminated portion. As a result, a specific pattern representing desired identification code is defined in the photosensitive layer 412. Thus, reflection representing a corresponding identification code will be generated by the surface acoustic waves transmitted to the first zone 41 based on the specific pattern on the photosensitive layer 412, thereby achieving the purpose of editing and writing information to the RFID device by using the light emitting device 51.

With reference to FIG. 6, there is shown a second embodiment of a system for editing RFID devices in accordance with the present invention, wherein the writing device is a punch 61 and the editable area 411 is a plastic layer 413 formed on the first zone 41 of the substrate 40. The punch 61 has a punch surface 611 with a predetermined pattern so that the shape of the plastic layer 413 can be changed by pressing the punch surface 611 of the punch 61 against the surface of the plastic layer 413. That is, a surface complementary to the shape of the punch surface 611 is formed on the plastic layer 413, so as to define a specific pattern representing desired identification code. Thus, reflection representing a corresponding identification code will be generated by the surface acoustic waves transmitted to the first zone 41 based on the specific pattern on the plastic layer 413, thereby achieving the purpose of editing and writing information to the RFID device by using the punch 61.

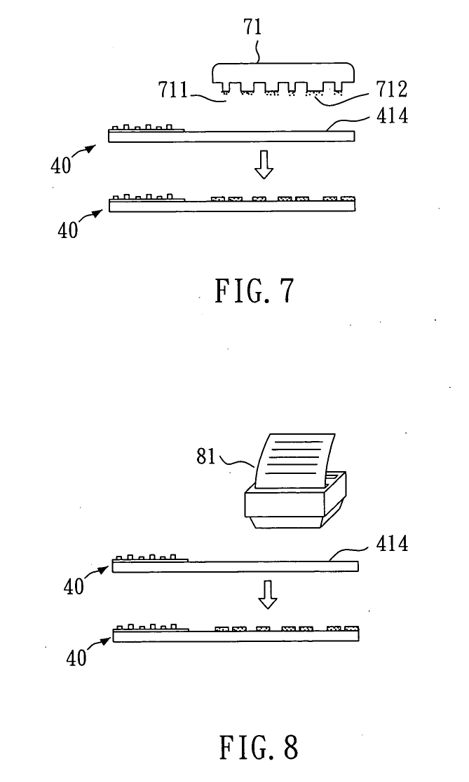

With reference to FIG. 7, there is shown a third embodiment of a system for editing RFID devices in accordance with the present invention, wherein the writing device is a stamp 71 and the editable area 411 is an empty region 414 formed on the first zone 41 of the substrate 40. The stamp 71 has a predetermined pattern on its bottom surface 711 with stamping material 712 adhered thereon. By pressing the bottom surface 711 of the stamp 71 against the surface of the empty region 414, the empty region 414 is stamped with stamping material 712 having the predetermined pattern, so as to define a specific pattern representing desired identification code. Thus, reflection representing a corresponding identification code will be generated by the surface acoustic waves transmitted to the first zone 41 based on the specific pattern on the empty region 414, thereby achieving the purpose of editing and writing information to the RFID device by using the stamp 71.

With reference to FIG. 8, there is shown a fourth embodiment of a system for editing RFID devices in accordance with the present invention, wherein the writing device is a printing apparatus 81 and the editable area 411 is an empty region 414 formed on the first zone 41 of the substrate 40. The printing apparatus 81 is provided to print a predetermined pattern on the surface of the empty region 414, so as to define a specific pattern representing desired identification code. Thus, reflection representing a corresponding identification code will be generated by the surface acoustic waves transmitted to the first zone 41 based on the specific pattern on the empty region 414, thereby achieving the purpose of editing and writing information to the RFID device by using the printing apparatus 81.

In view of the foregoing, it is known that the present invention provides an editable area on a substrate so that a user may operate a writing device to form a pattern representing an ID on the editable area. This enables a user to edit and write desired information into the RFID device in a flexible manner. Moreover, the writing device can be selected from one of light emitting device, punch, stamp, and printing apparatus. Further, information can be easily edited and written into the RFID device. As a result, the use of RFID device is very convenient.

Although the present invention has been explained in relation to its preferred embodiment, it is to be understood that many other possible modifications and variations can be made without departing from the spirit and scope of the present invention as hereinafter claimed.

1. An editable radio frequency identification device comprising:
a substrate including a first zone and an adjacent second zone on its top surface;
an editable area formed on the first zone for being operative to form a specific pattern representing an identification code thereon by means of a writing device;
a transducer formed on the second zone; and
an antenna connected to the transducer, and receiving electromagnetic waves, wherein the transducer is operative to convert the electromagnetic waves into surface acoustic waves for being sent to the first zone.

2. The editable radio frequency identification device as claimed in claim 1, wherein the editable area is a photosensitive layer formed on the first zone so that the specific pattern is formed on the photosensitive layer by using a light emitting device to emit light on a predetermined portion of the photosensitive layer to change chemical property of the predetermined portion.

3. The editable radio frequency identification device as claimed in claim 1, wherein the editable area is a plastic layer formed on the first zone so that the specific pattern is formed on the plastic layer by pressing a punch with a predetermined pattern against the plastic layer to change shape of the plastic layer.

4. The editable radio frequency identification device as claimed in claim 1, wherein the editable area is an empty region formed on the first zone so that the specific pattern is formed on the empty region by using a printing apparatus to print the specific pattern on the empty region or pressing a stamp with a pre-determined pattern on the empty region.

5. A system for editing radio frequency identification device, comprising:
a writing device; and
a radio frequency identification device including:
a substrate including a first zone and an adjacent second zone on its top surface;
an editable area formed on the first zone for being operative to form a specific pattern representing an identification code thereon by means of the writing device;
a transducer formed on the second zone; and
an antenna connected to the transducer, and receiving electromagnetic waves, wherein the transducer is operative to convert the electromagnetic waves into surface acoustic waves for being sent to the first zone.

6. The system as claimed in claim 5, wherein the writing device is a light emitting device and the editable area is a photosensitive layer formed on the first zone, so that the specific pattern is formed on the photosensitive layer by using the light emitting device to emit light on a predetermined portion of the photosensitive layer to change chemical property of the predetermined portion.

7. The system as claimed in claim 5, wherein the writing device is a punch with a predetermined pattern and the editable area is a plastic layer formed on the first zone so that the specific pattern is formed on the plastic layer by pressing the punch against the plastic layer to change shape of the plastic layer.

8. The system as claimed in claim 5, wherein the writing device is a printing apparatus and the editable area is an empty region formed on the first zone so that the specific pattern is formed on the empty region by using the printing apparatus to print the specific pattern on the empty region.

9. The system as claimed in claim 5, wherein the writing device is a stamp with a pre-determined pattern and the editable area is an empty region formed on the first zone so that the specific pattern is formed on the empty region by pressing the stamp to define the specific pattern on the empty region.
